(19) United States
(12) Patent Application Publication
(10) Pub. No.: US 2011/0036425 A1
(43) Pub. Date: Feb. 17, 2011

(54) APPARATUS FOR CONTROLLING A WATER-PRESSURIZATION SYSTEM

(76) Inventor: Ermanno Martinello, Torino (IT)

Correspondence Address: MERCHANT & GOULD PC, P.O. BOX 2903, MINNEAPOLIS, MN, 55402-0903, US

(21) Appl. No.: 12/599,945

(22) PCT Filed: May 13, 2008
(86) PCT No.: PCT/EP2008/003807

§ 371 Date: Oct. 25, 2010

(30) Foreign Application Priority Data
May 15, 2007 (IT) TO2007A000333

(51) Int. Cl. G05D 16/20

(52) U.S. Cl. 137/557; 137/565.01

(57) ABSTRACT

An apparatus (5) for controlling a water-pressurization system can be installed in a hydraulic circuit (1). The system includes an electric pump (2) connected to the hydraulic circuit (1) for pumping water therein, and an expansion vessel (3), provided with a valve (4) for controlling the pressure of the chamber containing air inside it, connected to the hydraulic circuit (1), designed to compensate for the variations of pressure to which the hydraulic circuit (1) is subjected in the steps of delivery of water. The apparatus (5) further includes a pressure sensor (7), installed in a position corresponding to the control valve (4), for detecting the pressure of the chamber containing air, and an electronic control unit (6), electrically connected to said electric pump (2) and to the pressure sensor (7), designed to measure constantly the pressure of the chamber containing air by the pressure sensor (7), so as to regulate activation or deactivation of the electric pump (2) on the basis of the value of pressure detected.

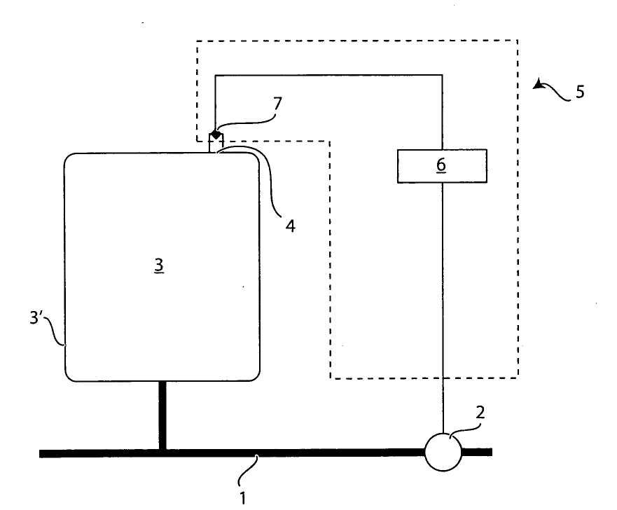

The present invention relates to an apparatus for controlling a water-pressurization system.

In greater detail, the invention concerns an apparatus that makes it possible to maintain efficiently and save the weakest part of a system for pressurization of water for residential or industrial purposes.

In what follows, the description will regard use in the residential field, but it is clearly evident how the invention is not to be considered limited to this specific use.

As is well known, a water-pressurization system applied to a hydraulic plant is provided principally with an electric pump, a pressure switch, and an expansion vessel.

Opening of any tap or cock of the plant causes a rapid decrease in the pressure in the hydraulic circuit of the plant. The expansion vessel restores water accumulated previously, preventing a sharp drop in pressure. When the pressure detected by the pressure switch is below a pre-defined intervention threshold, an electrical contact closes so as to actuate the water pump.

The next closing of the cock causes dilation of the membrane of the expansion vessel and a concomitant increase of the pressure in the circuit. Once then a deactivation threshold is exceeded in the opposite direction, the pressure switch opens the electrical contact, interrupting supply of the pump.

Using a pressure gauge it is possible to check the threshold pressures of activation-deactivation of intervention of the pressure switch.

The membrane expansion vessel is the most delicate point of the system. Said expansion vessel comprises a metal casing and a rubber membrane within it, constrained by means of a plate communicating with the piping (the hydraulic circuit). This configuration identifies two chambers. The first chamber, constituted within the rubber membrane, is invaded by water. The second chamber, formed by the external wall of the membrane and by the metal container, is occupied by compressed air.

As the pressure increases in the hydraulic circuit, there is an increase in the volume of water contained in the membrane. Consequently, there is a decrease in the volume of the chamber containing air, this determining the increase of pressure in the chamber itself countering the dilation of the membrane.

As the pressure of the hydraulic circuit decreases, the reverse process is set up; i.e., the greater pressure of the chamber containing air compresses the membrane, restoring to the hydraulic circuit the water and energy previously accumulated.

As may be readily appreciated, the rubber membrane works in abrasion against the metal and this entails a wear over the long term. It is not possible to solve the problem of this deterioration of the expansion vessel.

However, it should be noted that the wear of the membrane is caused principally by the fact that the membrane hardly ever works in ideal conditions, which are:
pre-charging of air equal to the pressure of actuation (minimum pressure) of the electric pump;
the pressure of deactivation (maximum pressure) is not higher than approximately twice the minimum pressure (for example 60-65%).

Another extremely important aspect is that very frequently the expansion vessel is undersized with respect to the water requirement.

This involves a greater number of actuations of the electric pump, thus leading to a rapid wear thereof, together with that of the pressure switch and obviously of the membrane. Furthermore, this also creates an energy consumption (due principally to starting of the electric pump) even three times higher than a plant that is properly sized.

Finally, also a troublesome effect of increase and decrease in the flow of water is produced since every few litres the pressure in the hydraulic circuit varies from the minimum to the maximum.

Another factor that tends to lead to considerable wear of the membrane of the expansion vessel is the phenomenon of osmosis, i.e., the permeability to air of the elastomer of which the membrane is made.

An extremely small part of the air of pre-charging, over a long time, passes through the rubber of the membrane in the water, thus determining a higher amount of work, a greater abrasion, and greater anomalous deformations of the membrane itself.

This phenomenon is all the greater, the more the pre-charge and the switch-on pressure differ (i.e., the lower the pre-charge) and when the maximum pressure is higher than twice the minimum.

It is known to persons skilled in the sector, in fact, that an expansion vessel is pre-charged in the factory where it is produced at a pre-set initial pre-charging pressure, in the region of 1.5 bar. Said pre-charging pressure enables the installer to assemble the pump/pressure switch/expansion vessel system without the need for it to be equipped with a compressor.

However, frequently the pressure is insufficient also because it is known that the pressure switches leave the factory in the majority of cases calibrated at from 1.2 to 2.4 bar.

Hence, the installer calibrates the pressure switch by raising the maximum control pressure and frequently tends to raise also the minimum. But in each of these two cases, he hardly ever modifies the pre-charging pressure of the vessel.

Amongst other things, in the assembly of pressurization systems with commercially available components, the installer can frequently find himself with an expansion vessel pre-charged at 3 bar and a pressure switch that performs ?switch-on at 1 bar. This implies that the expansion vessel is underused by as much as 80%.

Instead, in the case where the pressure switch envisages a threshold of actuation of the electric pump at 3 bar and the expansion vessel is pre-charged at 1 bar, there is the effect that the water tends to stagnate in the expansion vessel, because it does not empty off, and the membrane works excessively, reducing considerably the duration of the expansion vessel itself on account of excessive anomalous abrasions and deformations, in addition to the fact that an acrid smell of stagnant water is created.

Finally, in the case where the pressure were insufficient, an excessive difference is created between the maximum pressure and minimum pressure of actuation of the electric pump by the pressure switch, the system functions properly, thus solving the problem of proper delivery of water to the user, but at the serious expense of the duration of the membrane.

There may also occur phenomena that are apparently trivial but no less disadvantageous for the pressurization system. A very widespread custom is to check whether there is still pre-charging in the autoclave by pressing the stem of the air valve located generally at the top of the metal casing of the expansion vessel.

This occurs because the system once installed is no longer transparent and is increasingly less transparent over time because also the pressure gauge normally installed is of low quality and frequently does not function or supplies imprecise measurements. In any case, there is no way of regulating the plant in a correct way, without emptying the plant and using precision pressure gauges. As is evident, this involves considerable expenses and waste of time and the need for specialized staff.

In the light of what has been said, a purpose of the present invention is to propose an apparatus that is able to control the pressurization of a hydraulic system in a dynamic way on the basis of the pre-charging pressure of the expansion vessel; consequently, the mode of governing a pressurization or heating system is radically modified.

Another purpose of the present invention is to enable the user himself to restore proper operation of the system by simply emptying the vessel of water with the pump turned off.

Yet another purpose of the invention is to propose an apparatus that enables limitation of the phenomenon of osmosis and hence preserve the duration of the membrane of the expansion vessel.

A further purpose of the invention is to enable detection of proper sizing of the pressurization plant.

Consequently, forming a specific subject of the present invention is an apparatus for controlling a water-pressurization system which can be installed in a hydraulic circuit, said system comprising; an electric pump connected to said hydraulic circuit for pumping water therein; and an expansion vessel, provided with a valve for controlling the pressure of the chamber containing air inside it, connected to said hydraulic circuit, designed to compensate for the variations of pressure to which said hydraulic circuit is subjected in the steps of delivery of water; said apparatus being characterized in that it comprises: a pressure sensor, installed in a position corresponding to said control valve for detecting the pressure of said chamber containing air; and an electronic control unit, electrically connected to said electric pump and to said pressure sensor, designed to measure constantly the pressure of said chamber containing air by means of said pressure sensor so as to regulate activation or deactivation of said electric pump on the basis of the value of pressure detected.

Once again according to the invention, the control of said electric pump can be obtained by determining the thresholds of pressure of activation and deactivation thereof, and in particular said pressure thresholds of activation and deactivation of said electric pump can be such that said deactivation pressure is not higher than twice said activation pressure.

Yet again according to the invention, said apparatus can regulate the control of said electric pump so that the pre-charging pressure of the air of said chamber containing air of said expansion vessel is substantially equal to the pressure of activation of said electric pump.

Furthermore, according to the invention, said apparatus enables measurement of the pre-charging pressure of said expansion vessel when the hydraulic circuit is without water so as to calculate the thresholds of pressure of activation and deactivation of said electric pump.

Advantageously, according to the invention, said control unit can comprise means for counting the number of cycles of activation-deactivation with respect to a pre-definable time interval, preferably once a day, of said electric pump with respect to the amount of water required.

Once again according to the invention, said apparatus comprises a calibration device by means of which it is possible to fix a minimum pressure threshold of pre-charging of the air chamber of said expansion vessel by an installer. In addition, said control unit can comprise an alarm device designed to generate an alarm signal in the case where the pre-charging pressure drops below said minimum pre-charging-pressure threshold.

Yet again according to the invention, said control unit can comprise transceiver means, designed to send a telephone message, such as an SMS, in the case of any malfunctioning or failure.

Furthermore, according to the invention, said control unit can comprise an indicator, preferably a LED or the like, for warning of incorrect installation.

Advantageously, according to the invention, said apparatus can comprise an air-compressor unit, by means of which it is possible to restore or modify the pre-charging pressure of said expansion vessel.

The present invention will now be described by way of illustrative but non-limiting example, according to its preferred embodiments, with particular reference to the FIGURE of the attached drawing, which shows a scheme of operation of the apparatus for controlling a water-pressurization system according to the present invention.

With reference to the attached FIGURE, there may be noted a hydraulic circuit represented in the FIGURE by a stretch of duct 1, in which water can flow, on which a pressurization system or plant is installed. Said system comprises an electric pump 2 and an expansion vessel 3.

Said expansion vessel 3 is of course equipped with an air valve 4, set at the top of the metal casing 3′.

Said system or plant for pressurization of the water is controlled by an apparatus 5 provided with an electronic control unit 6, electrically connected to said electric pump 2 and to a pressure sensor 7 installed on said air valve 4.

Operation of the apparatus is described in what follows. The electronic control unit 6 constantly measures the pressure within the expansion vessel 3, and according to the value read controls the electric pump 2 so as to enable delivery of a power such as to force the water into the duct 1 at an appropriate pressure.

By means of the apparatus 5 forming the subject of the present invention, the installer is also able to measure the pressure of the chamber containing air inside the expansion vessel 3 in the absence of water. In other words, it is possible to detect the pre-charging pressure of the expansion vessel 3.

On the basis of this value, said control unit automatically calculates the thresholds of pressure of activation and deactivation of the electric pump 2, by means of which said control unit 6 itself activates the pump 2.

Consequently, the apparatus functions in a completely dynamic way. This enables variation at any moment of the pressure of activation and deactivation of the electric pump 2 as a function of the pre-charging pressure, thus safeguarding the service life of the membrane of the expansion vessel 3 and of the electric pump 2.

The control unit 6 can also envisage further functions. In particular, said control unit 6 is equipped with counter means (not illustrated in the FIGURE), which are able to detect the number of cycles of activation-deactivation of the electric pump as compared to a proper use. The datum is stored, and an alarm device (not illustrated in the FIGURE) signals the conditions of operation of the pump outside pre-definable parameters. This enables safeguarding of the service life of the parts of the water-pressurization system. It is known, in fact, that an electric pump is properly sized for the plant in which it is installed if it carries out a maximum of approximately 5 000 cycles of activation-deactivation per year.

In addition, the apparatus 5 comprises a calibration device, by means of which the installer can fix the desired minimum pre-charging pressure, below which the system generates an alarm by means of said alarm device.

Said control unit 6 also comprises an indicator, for example a LED or the like, for signalling incorrect installation of the apparatus 5.

Finally, the control unit 6 comprises transceiver means (not visible in the FIGURES) by means of which it sends a telephone message (e.g., an SMS) to the maintenance operator, signalling malfunctioning or failures.

Finally, the apparatus 5 can be equipped with an air-compressor unit, by means of which the installer or the maintenance operator can restore or modify the pre-charging of the expansion vessel 3.

In the case where the apparatus were to undergo a failure, it is regulated so as not to interrupt the delivery of water to the load, even though it is not well regulated.

On the basis of the foregoing description, it may be noted that the basic characteristic of the present invention is that the apparatus described is able to make an automatic calibration on the basis of the pre-charging pressure and that the pressure thresholds of activation-deactivation of the electric pump are dynamic.

The present invention has been described purely by way of illustrative, and non-limiting, example according to its preferred embodiments, but it is to be understood that variations and/or modifications may be made by persons skilled in the branch, without thereby departing from the corresponding sphere of protection, as defined by the annexed claims.

1. An apparatus for controlling a water-pressurization system which can be installed in a hydraulic circuit, said system includes
an electric pump connected to said hydraulic circuit for pumping water therein; and
an expansion vessel, provided with a valve for controlling pressure of the chamber containing air, connected to said hydraulic circuit, designed to compensate for the variations of pressure to which said hydraulic circuit is subjected in the steps of delivery of water; said apparatus comprising:
a pressure sensor, which can be installed in a position corresponding to said control valve, for detecting the pressure of said chamber containing air; and
an electronic control unit, electrically connected to said electric pump and to said pressure sensor, designed to measure constantly the pressure of said chamber containing air by said pressure sensor to regulate activation or deactivation of said electric pump on the basis of the value of pressure detected.

2. The apparatus according to claim 1, wherein the control of said electric pump is obtained by determining the thresholds of pressure of activation and deactivation of said electric pump.

3. The apparatus according to claim 2, wherein said thresholds of pressure of activation and deactivation of said electric pump are such that said pressure of deactivation is not higher than twice said pressure of activation.

4. The apparatus according to claim 1, wherein the control of said electric pump is regulated in such a way that pre-charging pressure of air of said chamber containing air of said expansion vessel is substantially equal to the pressure of activation of said electric pump.

5. The apparatus according to claim 4, wherein measurement of the pre-charging pressure of said expansion vessel is made possible when the hydraulic circuit is without water to calculate the thresholds of pressure of activation and deactivation of said electric pump.

6. The apparatus according to claim 1, wherein said control unit comprises means for counting the number of cycles of activation-deactivation with respect to a predefinible time interval, of said electric pump with respect to the amount of water required.

7. The apparatus according to claim 1, further comprising:
a calibration device by means of which it is possible to fix a minimum pressure threshold of pre-charging of the air chamber of said expansion vessel by an installer; and
said control unit comprises an alarm device designed to generate an alarm signal when the pre-charging pressure drops below said minimum pre-charging-pressure threshold.

8. The apparatus according to claim 1, wherein said control unit comprises transceiver means, designed to send a telephone message, in the case of any malfunctioning or failure.

9. The apparatus according to claim 1, wherein said control unit comprises an indicator, for warning of incorrect installation.

10. The apparatus according to claim 1, further comprising: an air-compressor unit, by means of which it is possible to restore or modify the pre-charging pressure of said expansion vessel.
